(19) United States
(12) Patent Application Publication
(10) Pub. No.: US 2010/0301102 A1
(43) Pub. Date: Dec. 2, 2010

(54) FLUXER FOR SOLDERING APPARATUS

(76) Inventor: Michael Tombs, Essex (GB)

Correspondence Address: DICKSTEIN SHAPIRO LLP, 1825 EYE STREET NW, Washington, DC, 20006-5403, US

(21) Appl. No.: 12/675,520

(22) PCT Filed: Aug. 26, 2008
(86) PCT No.: PCT/GB2008/002880

§ 371 Date: Jul. 26, 2010

(30) Foreign Application Priority Data
Aug. 28, 2007 (GB) 0716696.0

(51) Int. Cl. B23K 1/20; B23K 3/08

(52) U.S. Cl. 228/223; 228/33

(57) ABSTRACT

A fluxer comprises a spray head (15), a reservoir (3) for the flux (9) and a feed line (11) for feeding flux from the reservoir (3) to the spray head (15) by pressurising the reservoir with an air supply via a line (7). A return (12) line is provided from the spray head (15) so that cleaning fluid (9′) can be fed from a reservoir (3′) via line (11) and returned to a waste reservoir (19). A spray head has an electromagnetically operated piston (53) for spraying flux. The piston (53) is biased to a first position by a spring (49) to close a spray outlet aperture (63) and is moved against the force of the spring (49) by the electromagnet (71).

The present invention relates to a fluxer for soldering apparatus and in particular to a fluxer for a selective soldering apparatus.

In a soldering process for soldering components to a printed circuit board (PCB) in a production process it is usual to flux the underside to the board prior to soldering. The board may be fluxed completely, i.e. generally spayed on its underside, particularly prior to wave soldering in which the underside of the board is passed across the top of a wave of solder. In a selective soldering process it is preferred to flux only those areas which are to be soldered. Thus, spray fluxers which spray a small burst or jet of flux onto a small region of a board have been developed.

Commercial customers often dictate the type of flux to be used in a soldering operation, as well as the type of solder. For example, the requirements of a low value consumer product circuit board may differ substantially from military or aircraft requirements.

Effecting a changeover of flux is a time consuming operation. Where the flux is fed from a reservoir, it is still necessary to clean the fluxer spray head, which actually sprays flux onto the PCB. Since some fluxes use a water based solvent and others hydrocarbon or oil based, cleaning is important to ensure continued proper operation of the fluxer and to meet customer specifications. Changing the spray head can be difficult because of its location housed close to a hot solder bath in a complex selective soldering machine. Simply feeding cleaning fluid to a spray head is inefficient because a fluxer will typically emit only a very small volume of flux in a spaying operation hence a substantial amount of time would be required to pass sufficient cleaning fluid though the spray head.

In accordance with a first aspect of the invention, we provide a fluxer comprising a spray head, a reservoir for the flux and a feed line for feeding flux to the spray head from the reservoir, wherein a return line is provided for feeding flux or cleaning fluid from the spray head. Thus we provide a fluxer which can be readily cleaned in situ by feeding an appropriate solvent through the spray head prior to changing the flux.

The return line may feed to a waste reservoir. Thus, when the flux is to be changed, cleaning fluid may be pumped to the spray head through the feed line and return to a waste reservoir. Hence the flux head and feed line can be cleaned in situ. After feeding a cleaning fluid, the new type of flux can be pumped through the feed line and spray head to ensure the system is purged of cleaning fluid, prior to continuing operation of the fluxer.

Preferably flux is fed to the spray head under pressure, preferably greater than about 6 p.s.i. and preferably greater than about 10 p.s.i. The return line is normally closed off and so flux in the spray head is pressurised. In a cleaning operation, the return line is opened, a reservoir of cleaning fluid is connected to the feed line in place of the first flux reservoir and the cleaning fluid fed under pressure around the system to a waste reservoir. Where an aqueous flux is to be replaced with another aqueous flux, a water based cleaner can be used, and similarly a non-aqueous solvent based cleaner for changing between non-aqueous fluxes. For replacing an aqueous based flux with a non-aqueous flux, a suitable solvent such as alcohol is chosen to be compatible with both flux types.

In accordance with another aspect of our invention we provide a fluxer comprising a spray head having an electromagnetically operated piston for spraying flux. The piston is biased to a first position by a spring and moved against the force of a spring by an electromagnet. Preferably the piston operates a spraying stroke when the electromagnet is released, the spring force moving the piston to effect the pumping or spraying stroke. As the piston completes the spraying or pumping stroke, it closes an outlet aperture.

To effect a spraying stroke, the piston is withdrawn against the spring force by the electromagnet to allow flux to be forced ahead of the piston. The charge of flux is ejected though the outlet aperture.

The invention will be further described by way of example with reference to the accompanying drawings, in which:

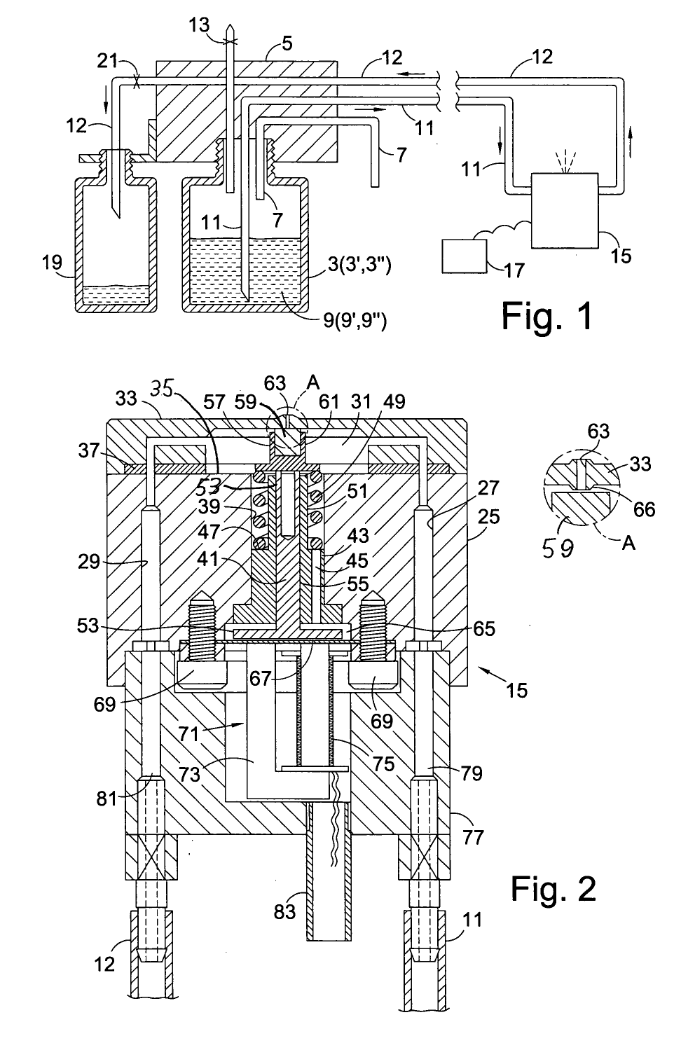

FIG. 1 illustrates a fluxer in accordance with the invention, and

FIG. 2 is a cross-section along a diameter through a spray head for a fluxer in accordance with the invention.

Referring to FIG. 1, a flux reservoir in the form of a bottle 3 is screwed into a housing manifold 5, forming an air tight seal with the manifold. An air pressure line 7 is connected to the manifold 5 to feed pressurised air into the bottle 3 above the flux 9. Flux is forced from the bottle 3 by the pressurised air, into a feed line 11. A pressure relief valve 13 is provided to bleed off excess pressure from the bottle 3. Feed line 11 delivers flux to a spray head 15, which will be described in more detail hereinafter. Spray head 15 is electronically controlled to perform a spraying operation via a switch or processor 17.

A return line 12 from the spray head 13 feeds to a waste reservoir 19 via a shut off valve 21. Waste reservoir 19 is carried on a bracket attached to the manifold 5.

In operation, flux reservoir 3 is connected to manifold 5 and pressurised air forces flux to the spray head 15 where it remains under pressure, valve 21 being closed. The spray head is operated as will be described hereinafter.

To change a flux reservoir, the pressurised air feed is interrupted and reservoir 3 replaced with a container 3′ of cleaning fluid 9′. Valve 21 is opened and pressurised air fed to the cleaning fluid reservoir 3′ to force the cleaning fluid though the spray head and out to the waste reservoir 19. The spray head may also be operated a few time to ensure cleaning of the spray outlet aperture.

Once the fluid entering the waste reservoir appears clean, the supply of pressurised air is interrupted and the cleaning fluid reservoir replaced with a reservoir 3″ of the new flux 9″. The new flux is then pumped around the system and into the waste reservoir 19 to ensure the feed line and spray head are filled and to displace any remaining solvent.

Prior to connecting the new flux reservoir, air can be blown through the system via feed line 11, by simply connecting an empty bottle 3, to evaporate the cleaning fluid.

Valve 21 is then closed and spraying using the new flux commenced.

Thus we provide a very simple and effective system of changing the flux whilst keeping the spray head in situ.

Referring to FIG. 2, the structure and operation of the spray head 15 will be described. A central housing 25 has through bores 27, 29 respectively forming an inlet and an outlet path to a valve chamber 31. Valve chamber 31 is formed by a capping plate 33 which is secured to an upper end 35 of the housing 25 with a gasket 37 in between. A central circular bore 39 in the housing 25 forms a compartment for a piston assembly 41. Bore 39 is lined by a liner 43 which is fixed in the bore 39 and has a plurality of axially extending throughways 45. Liner 43 has a reduced diameter portion 51 at its upper end to form a seat 47 for a compression spring 49 which extends around the reduced diameter portion 51.

A piston 53 of magnetisable material such as iron slides in a central bore 55 in the liner 43. A valve seat 57 is mounted on the upper end 58 of the piston 53 and carries an elastomeric seal 59 in a cup 61. The capping plate 33 has an outlet aperture 63 of dimeter about 0.2 mm (8 thou.). Spring 47 bears on the underside of valve seat 57 to urge the valve seat 57 and piston 53 upwards to close the outlet aperture 63 with the seal 59. A raised bump or ‘pip’ 66 is formed around the inner end of outlet aperture 63 to enhance the effect of seal 59.

The lower end 65 of the bore 39 is closed by a flexible steel membrane 67 about 0.2 mm (8 thou.) thick held in place by screws 69 to seal the lower end of the bore 39.

Below the membrane 39 an electromagnet 71 formed of a U-shaped iron core 73 and a coil 75 is housed in a bore in a lower housing member 77. Through bores 79, 81 in the lower housing member 77 connect with bores 27, 29 and are connected to feed and return lines 11, 12. A cable way 83 provides for electrical feed to the coil 75 of electromagnet 71.

To operate the spray head, flux is supplied under pressure, typically 6 p.s.i. or greater through the inlet bores 79, 27 to the valve chamber 31. We prefer a pressure of at least 10 p.s.i. When electromagnet 71 is not energised, the piston 53 is urged upwards by spring 47 acting on the valve seat 57, this closes outlet aperture 63. Valve 21 (FIG. 1) is closed. Thus, the valve chamber is pressurised. Flux can pass though to the bottom of the piston 53, via bores 45, to equalise the pressure around the piston 43.

When the electromagnet is energised, the piston 43 is attracted downwards. This allows flux to pass into a space between the seal 59 and outlet aperture 63. This movement of the piston is about 0.2 mm. (8 thou.). This moves seal 59 about 0.1 mm. (4 thou) clear of the lower end of aperture 63 to allow flux to enter the region above the seal and into the outlet aperture. When the electromagnet is turned off, spring 47 acts on the valve seat 57 to urge the piston 53 upwards to close the aperture 63 and complete ejection of a small quantity of flux through aperture 63.

To operate the electromagnet, an initially high voltage, say 42 V is applied for a few milliseconds to initiate movement of the piston, the voltage is then reduced, to 5V say, to hold the piston in the down, open position. The voltage is then switched off after a predetermined period of time, say 20 to 30 milliseconds, to release the piston and provide a metered jet of flux from aperture 63.

It will be appreciated that the timing and frequency of the spray operation may be adjusted to match different viscosity or surface tension of the flux material as well as the quantity of flux to be sprayed.

Various modifications will be apparent to those in the art and it is desired to include all such modifications as fall within the scope of the accompanying claims.

1. A fluxer comprising a spray head, a reservoir for the flux and a feed line for feeding flux from the reservoir to the spray head, wherein a return line is provided for feeding flux or cleaning fluid from the spray head.

2. A fluxer as claimed in claim 1, wherein a shut off valve is provided in the return line.

3. A fluxer as claimed in claim 1, wherein a compressed air supply line is provided for feeding compressed air into the reservoir to feed flux to the spray head.

4. A fluxer as claimed in claim 1, having a waste reservoir, the return line feeding to the waste reservoir.

5. A fluxer as claimed in claim 1 wherein the flux is fed to the spray head under a pressure of at least 6 p.s.i. and preferably at least 10 p.s.i.

6. A method of operating the fluxer of claim 1, comprising feeding cleaning fluid into the spray head via the feed line and receiving the cleaning fluid form the spray head via the return line.

7. A method as claimed in claim 6, wherein air is passed through the spray head via the feed and return lines to evaporate cleaning solvent.

8. A fluxer comprising a spray head having an electromagnetically operated piston for spraying flux.

9. A fluxer as claimed in claim 8, wherein the piston is biased to a first position by a spring to close a spray outlet aperture and is moved against the force of the spring by an electromagnet.

10. A fluxer as claimed in claim 8, wherein the spray head includes a chamber for flux and inlet and outlet feed lines to the chamber are provided for flowing a cleaning fluid through the chamber.

11. A fluxer as claimed in claim 8, 9 or 10, wherein a seal is provided on an end of the piston to close the spray outlet aperture.

12. A fluxer as claimed in claim 8, wherein the spray head is fed with flux under pressure.

13. A fluxer as claimed in claim 12, wherein the pressure is at least 6 p.s.i.
